(19) United States
(12) Patent Application Publication
(10) Pub. No.: US 2024/0389617 A1
(43) Pub. Date: Nov. 28, 2024

(54) Extrusion System and Method for Obtaining a Meat Analogue

(71) Applicant: ETH Zurich, Zurich (CH)

(72) Inventors: Martin Hofmann, Zürich (CH); Jan Vermant, Zürich (CH)

(21) Appl. No.: 18/696,638

(22) PCT Filed: Sep. 14, 2022
(86) PCT No.: PCT/EP2022/075543

§ 371 Date: Mar. 28, 2024

(30) Foreign Application Priority Data
Oct. 1, 2021 (EP) 21200428.7

(51) Int. Cl. A23J 3/26; A23J 3/22; A23P 30/25

(52) U.S. Cl. CPC A23J 3/26; A23J 3/227; A23P 30/25

(57) ABSTRACT

Provided is an extrusion system including an extruder and a die. The die includes a feed section with at least two ports for injecting a protein phase and/or fat phase, a feed channel, an extrusion plane with side walls and a die exit. Each of the ports is connected to an independent channel providing the protein phase and/or fate phase. The at least two ports lead into the feed channel. The feed channel leads to the extrusion plane such that the protein phase and/or fat phase is conveyed from the feed section to the extrusion plane. The extrusion plane has an isosceles triangular shape with the legs of the triangle forming the side walls and the base of the triangle forming the die exit. The feed channel leads into the extrusion plane at the apex of the triangle of the extrusion plane.

### CROSS REFERENCE TO RELATED APPLICATIONS

This application is the United States national phase of International Patent Application No. PCT/EP2022/075543 filed Sep. 14, 2022, and claims priority to European Patent Application No. 21200428.7 filed Oct. 1, 2021, the disclosures of which are hereby incorporated by reference in their entireties.

### BACKGROUND OF THE INVENTION

### Field of the Invention

The present invention refers to an extrusion system for a meat analogue and a method for obtaining a meat analogue featuring marbled meat inclusions.

### Description of Related Art

Meat analogues show promise as a sustainable protein supply source.

Existing production methods of meat analogues produce meat-like fibrillar structures only under very specific operating conditions. The exact mechanism of fibre formation is not well understood and control over the final structure relies on empirical observations.

Furthermore, the embedding of visually distinct fatty domains remains a challenge in the production of analogues for meat pieces, such as marbled beef steak analogues.

WO 2020/208544 A1 describes an approach for obtaining meat analogues having a fibrous macrostructure with fat injected into the voids of the fibrous macrostructure. The fat phase is described as filling the voids between the protein phase regions. While the approach described allows for a control of the fibrillation, a precise “marbling” is not possible.

Other production methods of marbled beef analogues that are currently investigated rely on 3D printing that is rather cost intensive and not feasible for mass production.

### SUMMARY OF THE INVENTION

Thus, it was an object of the present invention to provide a system and a method which allows for a better control of embedding the fat phase into the protein phase for mimicking the appearance of real meat pieces. At the same time the method should be applicable for mass production.

This object is solved by an extrusion system as described herein and a method for obtaining marbled meat using such an extrusion system.

Accordingly, an extrusion system for a meat analogue is provided, wherein the extrusion system comprises an extruder and a die; wherein the die comprises
a feed section with at least two ports for injecting a protein phase and/or fat phase (as feed entries), a feed channel, an extrusion plane with side walls,
wherein each of the ports (feed entries) is connected to an independent channel providing the protein phase and/or fate phase, and
wherein the at least two ports (feed entries) lead into the feed channel,
wherein the feed channel leads/connected to the extrusion plane such that the protein phase and/or fat phase is conveyed from the feed section to the extrusion plane,
Wherein the extrusion plane has an isosceles triangular shape with the legs of the triangle forming the side walls,
Wherein the feed channel leads into the extrusion plane at the apex of the triangle of the extrusion plane,
Wherein the side walls include the vertex angle α, wherein the vertex angle α is between 5°<α<60°,

In an embodiment of the present extrusion system the vertex angle α is between 10°<α<50°; preferably between 20°<α<45°, more preferably between 40°<α<50°; most preferably 45° C.

The present system and method as described later in more detail allows for marbling of a fat phase in a protein phase; i.e. the fat phase actively breaks the protein paste and does not “passively” fill voids as in the patent mentioned above, thereby mimicking the appearance of real meat pieces.

The present invention also allows for a structuring step allowing for a better control over the structure of the protein phase.

The present die system allows for good control over the “marbling” structure with parameters such as density of branches and orientation of fat regions versus extrusion direction. In particular, the fat phase actively forms the pattern through viscoplastic fracture.

Moreover, the inherent presence of a multiphase, interfacially dominated structure provides opportunities for interfacial polymerization and network formation to impart elasticity, replacing the current thermal denaturation of the proteins, which has negative consequences for taste.

At the same time, the system and method according to the invention enables high throughput and scalable methods through extrusion which will have economic advantages.

The present system is preferably designed to achieve marbling in an un-cooked protein dough. However, it is also possible to use other types of protein dough such as cooked protein dough.

In an embodiment of the present extrusion system, at least one of the ports for injecting the protein/fat phase into the feed channel is arranged downstream of the other port in the feed channel: i.e. the first and second port are aligned in series in the feed channel.

In a further embodiment the present extrusion system comprises at least three ports for injecting the protein/fat phase into the feed channel; i.e. providing three feed entries. In this design, a first port leads into the feed channel, and second and third side port lead into independent side channels, wherein said side channels lead into the feed channel. Thus, a 4 way junction is formed in the feed channel.

The dimension of the feed entry ports (i.e. slit size) and the channel may vary in a range between 100 μm and 100 mm, preferably 500 μm and 50 mm, more preferably 5 mm and 30 mm.

In an embodiment, a side channel with a feed entry port may be equipped with microchannels. Said microchannels may be formed by walls, in particular a series of walls. For example, a side channel with a feed entry port with a width of 5 −50 mm is preferably equipped with a series of separating walls forming a comb like port with smaller channels of 100 μm thickness. The port dimension of 100 μm provides an interesting structuring property: the paste is encoded with a wavelength producing a fibrillar structure.

It is also possible that further ports or inlets are provided in the feed section and/or the extrusion plane. The additional ports allow for instance the addition of a fat phase layer at the wall in the extrusion plane to mimick the fat layer on the outside of whole cut meat pieces.

In still a further embodiment the extrusion die is equipped with heating and cooling elements for in-line extrusion cooking.

In a further preferred embodiment of the present extrusion system the side walls of the extrusion plane are divided into a first section with a vertex angle α1 and a second section with a vertex angle α2, wherein vertex angle α1 is smaller than vertex angle α2, and wherein the feed channel leads into the first section of the extrusion plane, and the first section opens up into the second section. Thus, the extrusion plane has the form of a (reversed) funnel, wherein the feeding channel of the die leads into the narrower part of the funnel.

This specific geometry of the extrusion plane has a two-fold effect. Firstly, the structure of the extrudate (i.e. meat analogue) is obtained by forcing the ingredients through a certain stress field. In a triangular expansion die, stress fields show both perpendicular and flow aligned stress components. The ratio of these stress fields is given to a certain degree by the angle of the extrusion die. A combination of extrusion die angles will result in a combination of stress fields and thus a combination of structures. Secondly, the combination of two angles will allow to reach the same exit width over a shorter extrusion length—and therefore compresses the setup and lowers the dead volume.

In an embodiment the vertex angle α1 of the first section is between 5°<α1<60°; preferably between 15°<α1<50°; more preferably between 30°<α1<45°, and the vertex angle α2 of the second section is between 30°<α2<179°; preferably between 50°<α2<120°; more preferably between 80°<α2<100°.

As described above, the extrusion plane has an isosceles triangular shape with the legs of the triangle forming the side walls, and the base of the triangle forming the die exit. Thus, in a yet further preferred embodiment of the extrusion system the die comprises a die exit that is formed by said base of the extrusion plane. It is preferred, if the base of the extrusion plane forming the die exit has width or length between 25 mm and 250 mm, and wherein the height of the die exit is in a range between 1 mm and 250 mm, preferably between 100 mm and 200 mm.

In a further embodiment the extrusion system has a multilayered structure of superimposed elements, wherein one element comprises the extrusion plane and the feed channel and a further element comprises the feed ports.

In a more detailed variant the multilayered structure of superimposed elements comprises a first element with extrusion plane and feed channel, wherein the feed channel has a comb like structure (preferably the comb like structure is arranged in a widening of the feed channel opposite to the opening of the feed channel into the extrusion plane), a second element with an opening with a channel structure, a third element with an opening with meandering channels and a fourth element with feed ports.

Said elements are superimposed and aligned such the feed channel of the first element, the opening of the second element, the opening of the third element and the feed ports of the fourth element are in communication with each other such that the fat phase and/or protein phase can pass from the feed ports through the openings of the second and third element into the feed channel and into the extrusion plane.

The extrusion system allows for a method for extruding a meat analogue comprising a protein phase and a fat phase in an extrusion system, wherein the method comprises:
Applying a pressure to the protein phase and/or fat phase with the extruder,
Feeding the protein phase and/or fat phase from the extruder through the die in a direction flow,
Wherein the protein phase and/or fat phase is sequentially fed to the die through ports leading to the feed channel and subsequently to the extrusion plane, and
Collecting the meat analogue, preferably at the die exit.

The extrusion system allows for a sequential an/or continuous feeding of the protein phase and the fat phase, wherein the protein phase is fed in the feed section so as to cover the sides of the die wall. The fat phase is fed so as to be inserted between the protein phase feeds.

The protein and fat phases use their allocated channels and ports. The sequence is: feeding of the first phase through its allocated port, then feeding of the second phase through its allocated port.

The sequential feeding of the protein phase and fat phase is obtained through sequential operation of the pumps feeding the constituents or by exploiting flow instabilities, or in the presence of electrical fields. When exploiting flow instabilities, the two phases are fed continuously and the flow instabilities will cause a sequential feeding due to flow fluctuations (such as tip streaming).

The final composition of the meat analogue is defined by the flow rate ratio ρ of the fat phase flow rate over protein phase flow rate, wherein the flow rate ratio ρ is in the range 0.01<ρ<0.5.

The overall extrusion flow rate \dot{Q} lies in the range of 1 ml/min <\dot{Q}<1000 ml/min. The dimensions of the extrusion device can be scaled to accommodate higher flow rates.

The extruding method is conducted in a temperatures range between 15° C. and 160° C., preferably between 20° C. and 100° C., more preferably between 22° C. and 80° C., even more preferably between 25° C. and 50° C., with a particular emphasis on processing at room temperature.

The pressure ranges between 1 and 30 bar, preferably between 5 and 25 bar.

Finally, the collected meat analogue is cut to resemble a marbled meat.

For obtaining the marbled meat analogues. The present method uses
a protein phase, preferably consisting of a protein isolate suspension in water,
a fat phase, preferabyl consisting of a fat in water emulsion,

a third phase, serving as a proxy for connective tissue, such as a collagen-based hydrogel or other gelling agents, such as xanthan gum or arabica gum.

In an embodiment the protein phase comprises wheat protein (e.g., whole grain wheat or wheat gluten such as vital wheat gluten), corn protein (e.g., ground corn or corn gluten), soy protein (e.g., soybean meal, soy concentrate, or soy isolate), canola protein, rice protein (e.g., ground rice or rice gluten), cottonseed, peanut meal, pulse proteins (e.g. pea protein, faba bean protein), whole eggs, egg albumin, milk proteins, and mixtures thereof.

In some embodiments, the protein material comprises a non-meat protein such as gluten (e.g., wheat gluten). According to some embodiments, the raw material comprises a non-meat protein that does not include gluten.

In some embodiments, the protein material may optionally contain a soy-based ingredient, a corn-based ingredient or another cereal-based ingredient (e.g., amaranth, barley, buckwheat, fonio, millet, oats, rice, wheat, rye, sorghum, triticale, or quinoa).

In some embodiments, the protein material may comprise pea protein and faba bean protein, or may comprise pea protein, faba bean protein, and rice, or may comprise pea protein, faba bean protein, and gluten.

The protein material may optionally comprise a flour or a protein isolate. If flour is used, the protein material may include a non-animal-meat-based protein. Therefore, an ingredient may be used that is both a vegetable protein and a flour. Non-limiting examples of a suitable flour are a starch flour, such as cereal flours, including flours from rice, wheat, corn, barley, and sorghum; root vegetable flours, including flours from potato, cassava, sweet potato, arrowroot, yam, and taro; and other flours, including sago, banana, plantain, and breadfruit flours. A further non-limiting example of a suitable flour is a legume flour, including flours from beans such as favas, lentils, mung beans, peas, chickpeas, and soybeans. If a protein isolate is used, the raw material may include, for example, protein isolate from faba bean, lentils, or mung beans.

In some embodiments, the fat phase may comprise a fat such as a vegetable fat and/or an animal fat. According to some embodiment, the fat source is an animal fat source such as chicken fat, tallow, and/or grease. A vegetable oil, such as corn oil, sunflower oil, safflower oil, rape seed oil, soy bean oil, olive oil and other oils rich in monounsaturated and polyunsaturated fatty acids, may be used. In some embodiments, a source of omega-3 fatty acids is included, such as one or more of fish oil, krill oil, flaxseed oil, walnut oil, or algal oil. In an embodiment, the fat material used to fill the voids in the meat analogue matrix may be a fat analogue (e.g., hydrocolloids, gellified emulsion of fat and high internal phase emulsions (HIPE): allowing for a low-fat content fat phase), vegetable fibers, and/or connective tissue analogue (e.g., protein gum matrices which have a similar structure to meat connective tissues).

In some embodiments, the raw material and/or fat may comprise sea animal based ingredients such as shrimp, fish and krill. In other embodiments, sea animal based ingredients may be substantially or completely absent from the raw material and/or fat.

The raw material may include other components in addition to proteins and flours, for example one or more of a micronutrient, a vitamin, a mineral, an amino acid, a preservative, a colorant and a palatant.

Non-limiting examples of a suitable vitamin include vitamin A, any of the B vitamins, vitamin C, vitamin D, vitamin E, and vitamin K, including various salts, esters, or other derivatives of the foregoing. Non-limiting examples of a suitable mineral include calcium, phosphorous, potassium, sodium, iron, chloride, boron, copper, zinc, magnesium, manganese, iodine, selenium, and the like.

Non-limiting examples of a suitable preservative include potassium sorbate, sorbic acid, sodium methyl para-hydroxybenzoate, calcium propionate, propienie acid, and combinations thereof. Non-limiting examples of a suitable colorant include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. A non-limiting example of a suitable palatant is yeast. Non-limiting examples of suitable palatants include yeast, tallow, rendered animal meals (e.g., poultry, beef, lamb, and park), flavor extracts or blends (e.g., grilled beef), animal digests, and the like.

In an embodiment, a natural colorant and flavor component may be injected into the dough during and/or after an extrusion process. In an embodiment, one or more natural colorants such as lycopene from tomato or betaine from beetroot and/or a mixture thereof used to simulate a natural meat color of a meat analogue. For example, the meat analogue make take the form of a marbled beef steak including a red-brown coloring, steak-like shape such as ribeye or top loin, and contain regions of meat analogue visually distinct from regions of fat and/or fat analogues. In such an embodiment, the visually distinct regions comprise different formulations relative to each other (i.e., animal protein or fat).

### BRIEF DESCRIPTION OF THE DRAWINGS

The invention is explained in the following in more detail by means of examples with reference to the Figures.

FIG. 1A Schematic top view of an extrusion die according to a first embodiment of the invention with (1) the feed entries, (2) the feed channel, (3) the extrusion plane and (4) the die exit.

FIG. 1B Obtained marbled structure featuring fat inclusion in protein mass.

FIG. 2 View of the cross section of the extrudate, 3 cm wide and 5 mm high.

FIG. 3A Schematic top view of an extrusion die of a second embodiment according to the invention with (1) the feed entries, (2) the feed channel, (3) the extrusion plane and (4) the die exit.

FIG. 3B the elongated structure of the protein phase (green) can be seen continuously thinning in the extrusion plane.

FIG. 4 Schematic top view of an extrusion die of a third embodiment according to the invention with (1) the feed entries, (2) the feed channel, (3) the extrusion plane with a first section and a second section, and (4) the die exit.

FIG. 5A Top view of a side channel provided with microchannels.

FIG. 5B Oblique side view of the side channel provided with microchannels of FIG. 5A.

FIG. 6 a schematic view of a fourth embodiment according to the invention.

### DESCRIPTION OF THE INVENTION

### Example 1

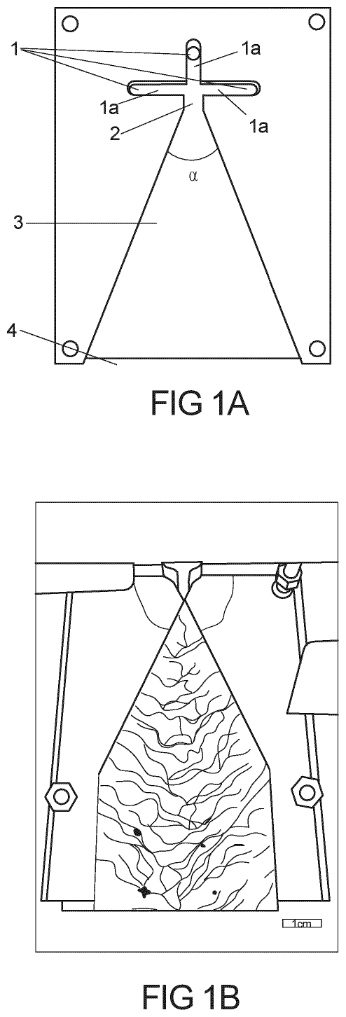

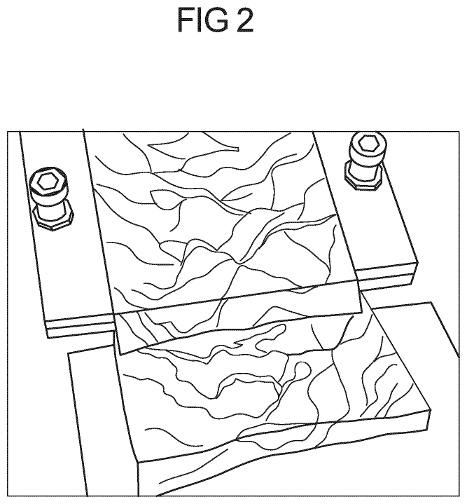

A first extrusion device (FIG. 1A shows a top view of the device) is a die comprising a feed section with feed entries or ports (1), a feed channel (2) and an extrusion plane (3). The feed section allows for the feed of the constituents. The particular arrangement shown here features three feed entries (1). Every feed entry (1) is connected to an independent side channel (1a) leading to a four-way junction with the fourth channel being the feed channel (2). The feed can occur from top, bottom or back of the plate. The feed channel (2) conveys the constituents from the feed section to the extrusion plane (3). The extrusion plane's walls are arranged at an angle α so as to form a single chamber with a widening distance between the walls until the die exit (4) is reached (300<α<60°). The die exit width range from 25 mm to 250 mm.

The extrusion die height lies in the range of 1 mm to 250 mm. The die can be equipped with heating and cooling elements so as to allow for in-line extrusion cooking. Further inlets can be added in the feed section and in the extrusion plane.

The method consists in the sequential feeding of the protein phase and the fat phase (FIG. 1B shows the obtained structure). The protein phase (in red) is fed in the feed section so as to cover the sides of the die wall. The fat phase (in white) is fed so as to be inserted between the protein phase feeds. The sequential feeding can be obtained through sequential operation of the pumps feeding the constituents or by exploiting flow instabilities such as tip streaming, also in the presence of electrical fields.

The flow rate ratio ρ is defined as the ratio of the fat phase flow rate over protein phase flow rate. «p» defines the final composition and can span the range 0.01<ρ<0.5.

The overall extrusion flow rate \dot{Q} lies in the range of 1 ml/min <\dot{Q}<1000 ml/min. The dimensions of the extrusion device can be scaled to accommodate higher flow rates.

The resulting product has the macroscopic texture of marbled meat and can be collected at the exit of a simple extrusion die. The current setup could also be combines with other extrusion devices which would act as feed to the present die, so that structuring at multiple length scales is possible. Also the possibility of using the large interfacial area for crosslinking reactions could lead to improved properties without negative taste effects.

### Example 2

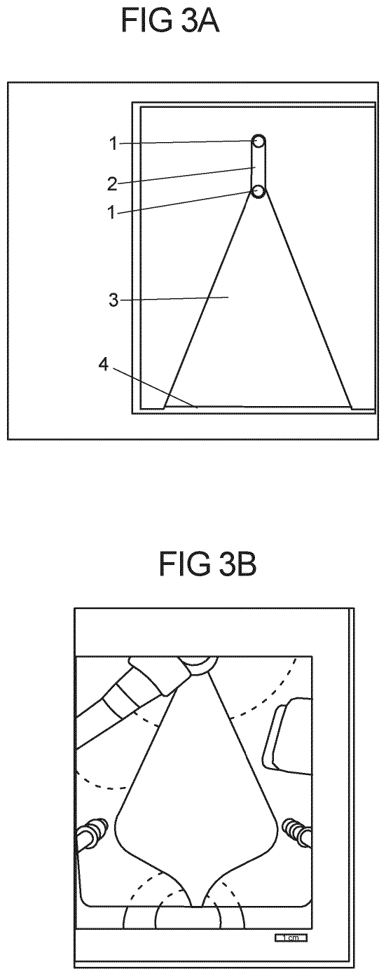

FIG. 3A shows a second configuration of the die. Again, the die comprises a feed section with feed entries or ports (1), a feed channel (2), and an extrusion plane (3).

The feed section allows for the feed of the constituents. The particular arrangement shown in FIG. 3A features two feed entries (1). The first feed entry feeds into the feed channel (2). The second feed entry feeds directly into the feed channel downstream of the first feed entry. The feed channel (2) conveys the constituents from the feed section to the extrusion plane (3). The extrusion plane's walls are arranged at an angle so as to form a single chamber with a widening distance between the walls until the die exit (4) is reached. The die can be equipped with heating and cooling elements so as to allow for in-line extrusion cooking.

The method consists in the sequential feeding of the protein phase with a third phase serving as a proxy for connective tissue. A finite volume of the protein phase reaches the extrusion plane and continuously thins as it is pushed radially towards the die exit, therefore allowing for a precise control over the protein phase thickness. In FIG. 3B the die geometry then further folds the obtained strands of protein phase, finally collected as structured threads.

### Example 3

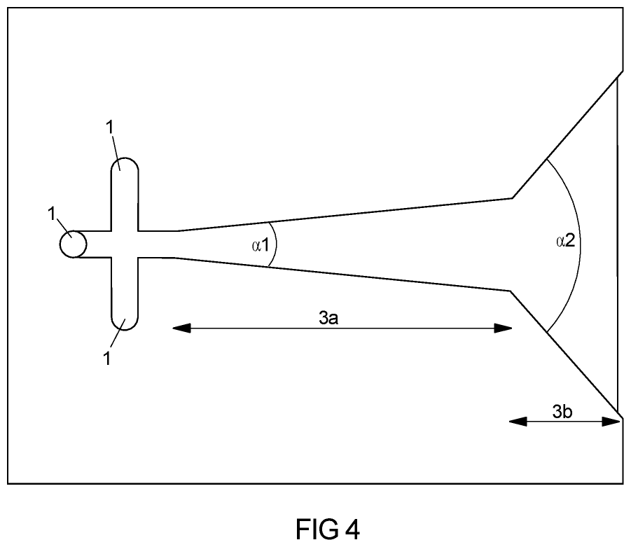

FIG. 4 shows a third configuration of the die. Similar to the embodiment shown in FIG. 1A the die comprises a feed section with feed entries (1), a feed channel (2) and an extrusion plane (3). The feed section comprises three feed entries (1). Every feed entry is connected to an independent side channel leading to a four-way junction with the fourth channel being the feed channel (2).

In addition, the side walls of the extrusion plane are divided into a first section 3a with a vertex angle α1 and a second section 3b with a vertex angle α2, wherein vertex angle α1 is smaller than vertex angle α2.

The feed channel (2) leads into the first section (3a) of the extrusion plane (3), and the first section (3a) opens up into the second section (3b). The vertex angle α1 of the first section is between 5° <α1<45° and the vertex angle α2 of the second section is between 35°<α2<179°.

The side walls of the first section (3a) have a length 1 and the side walls of the second section (3b) have a length 2, wherein the ratio of length 1 and 2 is between 0.1<length 1/length 2<10.

### Example 4

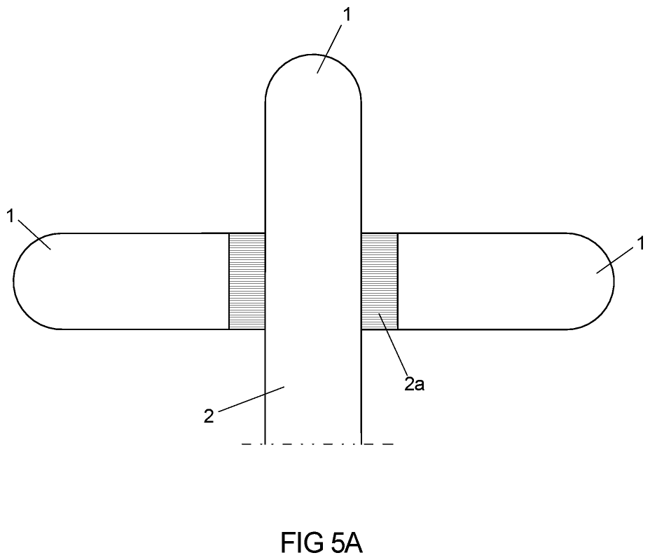

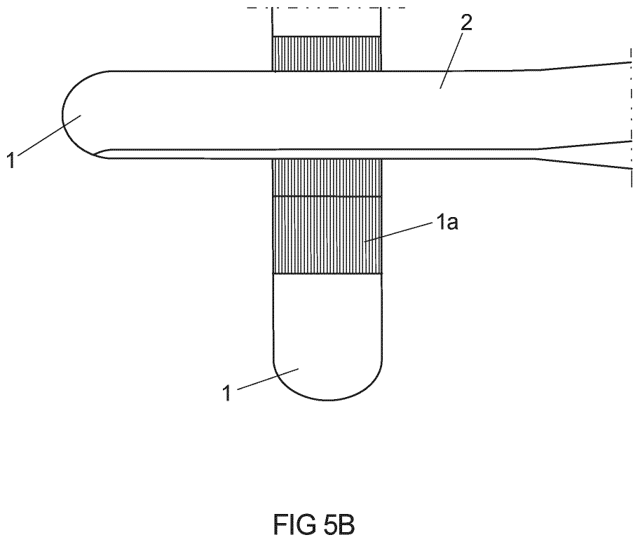

FIGS. 5A and 5B show an embodiment of the side cannels. Here, the side channel with feed entry port is equipped with microchannnels (2a). Said microchannels may be formed by walls, in particular a series of walls. For example, a side channel with a feed entry port with a width of 5 mm is equipped with a series of separating walls forming a comb like port with smaller channels of 100 μm thickness

### Example 5: Meat Analogue Marbling

The objective of the process is to produce a marbled meat analogue. To this end three phases:
the protein phase mimicking the muscle meat,
the fat phase
the structuring phase mimicking the connective tissue in meat.

### 1/Protein Phase Structuring

In a first step the aim was at conferring a desired length scale to the protein phase. Muscle meat is composed of fibers and fascies with diameters of the order of 100 μm. The aim was therefore to produce domains of the protein phase of such thicknesses.

It was made use of a radial expanding die with alternate feed of the protein and structuring phase. A finite volume is pushed radially towards the exit of the die and is obtained using following formula for a desired thickness l.

$$V = \frac{{α}_{d i e}}{2 π} * π ( {{R}_{e x i t}}^{2} - {( {R}_{e x i t} - l )}^{2} ) * h$$

Where α_{die} stands for the extrusion angle, Rₑₓᵢₜ the distance from the opening of the triangular die extrusion plane and exit point, l the thickness of the domain, h the height of the extrusion plane.

The components are filled in syringes (scaled up to other containers), placed on syringe pumps (scaled up to worm pumps, melt pumps). An external electronic control on Arduino Uno (scaled up to bespoke circuitry) governs the time sequence of the feeding. The combined feeding time and flow rate \dot{Q} define the volume fed in the extrusion plane. For an experimental setup of:

$${α}_{d i e} = 45 ° , {R}_{e x i t} = 55 mm , l = 100 μm , h = 5 mm , \dot{Q} = 4 ml / min$$

a feeding time of 259 milliseconds is required.

Pauses were build in between feeding sequences, so as to obtain a final feeding loop of:
protein phase feed (259 milliseconds \dot{Q}=5 ml/min)
pause (1000 milliseconds)
structuring phase (200 milliseconds at \dot{Q}=1 ml/min)
pause (1000 milliseconds)

The obtained protein phase is recuperated in a beaker and fed in a syringe for step 2.

### 2/Protein Phase Marbling

The underlying process is the same as in step 1. The desired feeding of the structured protein and fat phases is dictated by the final desired fat content lying in the range of 5 wt. % to 30 wt. %.

For a fat content of 30 wt. %, the feed sequence is adapted to:
protein phase feed (5000 milliseconds \dot{Q}=2.5 ml/min)
pause (5000 milliseconds)
structuring phase (3500 milliseconds at \dot{Q}=1.5 ml/min)
pause (5000 milliseconds)

### Example 6

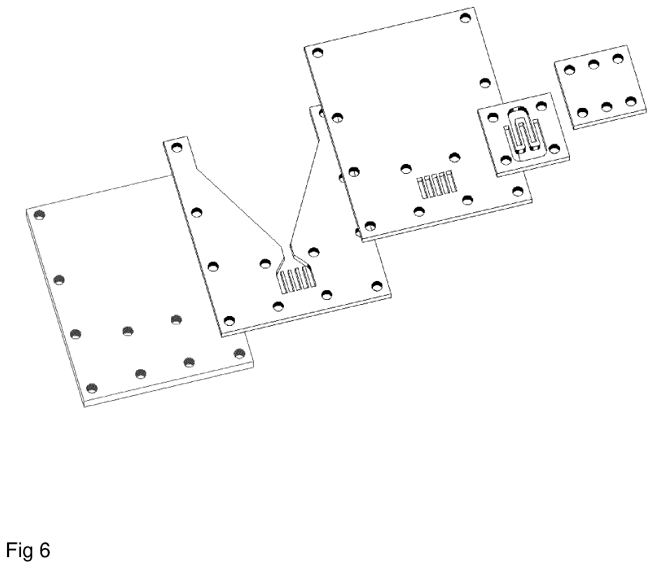

FIG. 6 shows a third configuration of the extrusion die. Similar to the embodiment as described in FIG. 3A, the die comprises a feed section with feed entries or ports (1), a feed channel (2), and an extrusion plane (3). The feed section allows for the feed of the constituents.

The particular arrangement shown in FIG. 6 features a modified multilayered geometry of the extrusion die.

Specifically, extrusion plane and feed channel are arranged in one layer or first element. The feed channel comprises a widening with comb like structures at the end of the channel opposite to the opening into the extrusion plane.

The extrusion plane and feed channel are covered by a further layer or second element, wherein said further second element comprises an opening with a channel structure. This second element is being arranged on the first element such that the channel structure opening is superimposed on the comb like structures of the feed channel of the first element.

A further, third element is superimposed on the channel structure opening of the second element. Said third element comprises an opening with channels arranged in a meandering form.

Subsequently this third element is superimposed by a fourth element with two feed ports for feeding the protein and/or fat phase. The protein and/or fat phase are pressed through the openings of the multilayered structure; through the meandering channel opening of the third element, the channel structure opening of the second element and subsequently into the comb like structures of the feed channel into the extrusion plane.

This specific multilayered structure allows a continuous pumping of the protein and/or fat phases.

1. An extrusion system for a meat analogue the extrusion system comprising an extruder and a die; wherein the die comprises
a feed section with at least two ports for injecting a protein phase and/or fat phase (as feed entries), a feed channel, an extrusion plane with side walls,
wherein each of the ports is connected to an independent channel providing the protein phase and/or fate phase, and
wherein the at least two ports lead into the feed channel,
wherein the feed channel leads to the extrusion plane such that the protein phase and/or fat phase is conveyed from the feed section to the extrusion plane,
wherein the extrusion plane has an isosceles triangular shape with the legs of the triangle forming the side walls of the extrusion plane,
Wherein the feed channel leads into the extrusion plane at the apex of the triangle of the extrusion plane,
wherein the side walls include the vertex angle α, wherein the vertex angle α is between 5°<α<60°.

2. The extrusion system according to claim 1, wherein at least one of the ports for injecting the protein/fat phase into the feed channel is arranged downstream of the other port in the feed channel.

3. The extrusion system according to claim 1, comprising at least three ports for injecting the protein/fat phase into the feed channel.

4. The extrusion system according to claim 3, wherein a first port leads into the feed channel, and second and third port lead into independent side channels, and wherein said side channels lead into the feed channel.

5. The extrusion system according to claim 1, wherein the vertex angle α is between 15°<α<50°; preferably between 30°<α<45°.

6. The extrusion system according to claim 1, wherein the side walls of the extrusion plane are divided into a first section with a vertex angle α1
and a second section with a vertex angle α2, wherein vertex angle α1 is smaller than vertex angle α2, and wherein the feed channel leads into the first section of the extrusion plane, the first section opens up into the second section.

7. The extrusion system according to claim 6, wherein the vertex angle α1 of the first section is between 5°<α1<60°; preferably between 15°<α1<50°; more preferably between 30°<α1<45°, and the vertex angle α2 of the second section is between 30°<α2<179°; preferably between 50°<α2<120°; more preferably between 80°<α2<100°.

8. The extrusion system according to claim 1, wherein the die comprises a die exit that is formed by the base of the triangle of the extrusion plane.

9. The extrusion system according to claim 8, wherein the base of the extrusion plane forming the die exit has width between 25 mm and 250 mm, and wherein the height of the die exit is in a range between 1 mm and 250 mm, preferably between 100 mm and 200 mm.

10. The extrusion system according to claim 1, wherein the extrusion die is equipped with heating and cooling elements for in-line extrusion cooking.

11. The extrusion system according to claim 1, comprising a multilayered structure of superimposed elements, wherein one element comprises the extrusion plane and the feed channel and a further element comprises the feed ports.

12. The extrusion system according to claim 11, wherein the multilayered structure of superimposed elements comprises a first element with extrusion plane and feed channel, wherein the feed channel has a comb like structure, a second element with an opening with a channel structure, a third element with an opening with meandering channels and a fourth element with feed ports.

13. The extrusion system according to claim 12, wherein the elements are superimposed and aligned such the feed channel of the first element, the opening of the second element, the opening of the third element and the feed ports of the fourth element are in communication with each other such that the fat phase and/or protein phase can pass from the feed ports through the openings of the second and third element into the feed channel and into the extrusion plane.

14. A method for extruding a meat analogue comprising a protein phase and a fat phase in an extrusion system according to claim 1, wherein the method comprises the steps of:
applying a pressure to the protein phase and/or fat phase with the extruder,
feeding the protein phase and/or fat phase from the extruder through the die in a direction flow,
wherein the protein phase and/or fat phase is sequentially or continuously fed to the die through ports leading to the feed channel and subsequently to the extrusion plane, and
collecting the meat analogue at the die exit.

15. The method according claim 14, wherein the sequential feeding of the protein phase and fat phase is obtained through sequential operation of the pumps feeding the constituents or by exploiting flow instabilities, such as tip streaming, or in the presence of electrical fields.

16. The Method according to claim 14, wherein the final composition of the meat analogue is defined by the flow rate ratio ρ of the fat phase flow rate over protein phase flow rate, wherein the flow rate ratio ρ is in the range 0.01<ρ<0.5.

17. The method according to claim 14, wherein the overall extrusion flow rate \dot{Q} is in the range of 1 ml/min<\dot{Q}<1000 ml/min.

18. The method according to claim 1, wherein the collected meat analogue is cut to resemble a marbled meat.
